(19) United States
(12) Patent Application Publication
(10) Pub. No.: US 2009/0234504 A1
(43) Pub. Date: Sep. 17, 2009

(54) LIFTING SYSTEM

(75) Inventors: Lothar Mikowski, Offenburg (DE); Klaus Muller, Berghaupten (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: HYDRO-GERATEBAU GMBH & CO. KG HEBEZEUGE, Biberach/Baden (DE)

(21) Appl. No.: 12/161,723

(22) PCT Filed: Dec. 21, 2006
(86) PCT No.: PCT/EP06/12371

§ 371 Date: Jul. 22, 2008

(30) Foreign Application Priority Data
Feb. 16, 2006 (DE) 10 2006 007 504.8

(51) Int. Cl. B66F 3/46; B66F 3/24; G05B 15/02

(52) U.S. Cl. 700/275; 254/1

(57) ABSTRACT

A lifting system (1) for lifting loads, for example for lifting and recovering an aircraft (2) following an accident is provided, and has a lift (6) which can be positioned underneath a load, in particular underneath a wing (5) of an aircraft. The lift (6) has at least three lifting cylinders (8) or similar lifting elements and a docking head (9) for coupling to a load receiving point. A measurement system is provided in order to detect the position of the docking head (9) and to measure the load vector that occurs at the docking head (9). A control device is connected to the measurement system, for mutually independent, load controlled or movement controlled confirmation of the individual lifting cylinder drives.

### BACKGROUND

The invention relates to a lifting system for lifting loads with a lift that can be positioned underneath the load.

The load to be lifted can be an airplane, in particular, an airplane to be recovered following an accident. Airplanes involved in accidents during takeoff or landing, for example, airplanes rolling off the runway can have damage to their landing gear, wherein one or more parts of the landing gear can become bent or can break off, so that the airplane comes to rest at an angle with one wing on the ground.

For recovering the airplane, the airplane must be lifted on the lowered side, so that the defective landing gear is accessible, in order to bring the airplane into a transportable state. In the lifted position, repairs to the damaged landing gear can possibly be performed or if the landing gear is not extended, attempts can be made to extend the landing gear. Independent of the damage, it is necessary to lift the airplane and bring it into a position, in which it can roll itself or can be towed or a recovery vehicle can be brought underneath the airplane.

It is known to use inflatable air cushions as lifts for lifting the airplane, wherein the air cushions are placed at positions set by the manufacturer of the airplane. Due to the limited side stability of these air cushions, only a relatively small lifting height of, for example, 80 cm, is possible. In practice, however, lifting heights of several meters are necessary, for example, 6 m. Accordingly, the use of such air cushions is associated with considerable problems. After reaching the maximum lift of the air cushion, it is necessary to support the airplane in this position, to bleed the air out of the air cushion, to prop up the air cushion, and then to lift the airplane by another 80 cm by inflating the air cushion. Three-leg lifts, which are placed at given airplane receiving points, can be used for support in the intermediate lift position.

Thus, for large lifting heights a considerable expenditure of time is necessary in addition to the problems, in particular, due to the multiple lifting, supporting, and propping steps. Because the takeoff and landing runway is blocked for the time required for recovering the airplane involved in an accident, under some circumstances considerable costs are incurred due to other airplanes being blocked from taking off and landing. The time factor thus plays a decisive role.

### SUMMARY

The objective of the present invention is to create a lifting system with a lift, with which loads and, in particular, airplanes involved in an accident can be lifted and recovered quickly and safely.

For meeting this objective it is provided that the lift has at least three lifting elements and a docking head for coupling with a load receiving point, that a measurement system is provided for detecting the position of the docking head and also for measuring the load vector occurring at the docking head, and that a control device connected to the measurement system is provided for mutually independent, load-controlled, or movement-controlled activation of the individual lifting element drives.

Through the use of such a lift, the lifting process, in particular, for an airplane lowered on one side, can be performed just with this lift. Additional air cushions and, in this way, in particular, the time-intensive changing between the step-by-step lifting with the air cushion and the support with a lift are not necessary.

The combination of the lift with the measurement system for detecting the position and also for measuring the load on the docking head and the lifting elements that can be activated independent of each other allows an automatic adaptation to the positioning path of the load receiving point or of the airplane receiving point (wing jacking point) when lifting an airplane. Thus, the load or the airplane is lifted with no side load. Here, the docking head of the lift follows the load receiving point of the load (airplane), because this docking head can be freely positioned horizontally and vertically.

When lifting the airplane, the curve profile of the receiving point path is dependent on the provided remaining contact points that are spaced apart from the receiving point, thus, for example, the still intact landing gear or other contact points of the airplane with the ground. Thus, the curve profile of the receiving point path is not set rigidly, but instead is dependent on each accident situation. By measuring the load at the docking head, the transverse force acting on the docking head is measured and a side movement is superimposed on the lifting movement as a function of this transverse force for compensating for the transverse force.

According to one embodiment, force sensors can be provided for measuring the load on the docking head. However, there is also the possibility that axial force sensors or pressure sensors are provided on the lifting elements for measuring the load on the docking head. In both variants, loads in the coordinate directions X, Y, Z and thus transverse loads and support loads can be detected.

For movement control, the position of the docking head is detected. For this purpose, length measurement devices can be provided on the lifting elements.

For a statically defined system, which can also receive transverse forces, in addition to the three lifting elements, a telescoping middle brace can also be provided. In this embodiment, for detecting the position of the docking head, a length measurement device and also two angle measurement devices can be provided on the middle brace. The middle brace is used only for guiding the docking head. Therefore, the inner hollow space can be used for holding the length measurement device and the angle measurement devices with the advantage that these measurement devices are housed in a way that is well protected from damage.

For a statically defined system, in which the docking head can receive transverse forces, different embodiments of bearings for the lifting elements or the middle brace can be provided, on one side, on the foot and, on the other side, on the docking head.

For an embodiment with three lifting elements, the associated lifting element foot points can be mounted in ball-and-socket joints, while the connections between the upper lifting element ends and the docking head are provided by means of a pin.

According to one embodiment with three lifting elements and one middle brace, the respective four foot points can be mounted in ball-and-socket joints and the connection between two of the upper lifting element ends and the docking head can be formed by ball-and-socket joints, the connection between the third upper lifting element end and the docking head can be formed by a pin, and the connection between the middle brace and the docking head can be rigid.

Furthermore, there is the possibility that for an embodiment with three lifting elements and one middle brace, the foot points of the lifting elements are mounted in ball-and-socket joints and the foot point of the middle brace is gimbaled, and the connection between the upper lifting element ends and the docking head is provided by ball-and-socket joints and the connection between the middle brace and the docking head is rigid.

The lifting elements can be constructed as hydraulic lifting cylinders or as electromechanical lifting cylinders.

Preferably, a control unit, which comprises at least one hydraulic pump, control valve, and hydraulic tank, is allocated to the lift as part of the lifting system, wherein the control unit is housed, in particular, in a carriage and a connection to the lift is provided by power supply and measurement and control lines. The control unit is thus a separate unit, which is easily transportable and can be connected to the lift and to the sensors installed there the power supply and measurement and control lines provided preferably with quick-release locks. The hydraulic pump can be driven electrically by a generator or, as one variant, can be an air-hydraulic pump driven by a compressor. The embodiment with compressor air-hydraulic pump is then advantageous if, for example, during the airplane recovery, additional devices with compressed-air needs are used, which can then be powered by the compressor.

Advantageously, the control device has an electronic controller, in particular, with a microprocessor, proportional valves, and similar control means, which features both load-controlled and also movement-controlled operation. A movement-controlled travel is provided for setting the lift on the load receiving point, while a force-controlled travel is provided for tracking the receiving point for X-Y movements.

Additional constructions of the invention are listed in the other subordinate claims.

### BRIEF DESCRIPTION OF THE DRAWINGS

Below the invention is explained in more detail with its essential details with reference to the drawings.

Shown are:

FIG. 1 is a front view of an airplane involved in an accident with only a partially extended landing gear,

FIG. 2 is a perspective view of a lifting system with a three-leg lift and also a control unit, which is connected to the lift by power supply and measurement lines,

FIG. 3 is a side view of a retracted three-leg left,

FIG. 4 is a top view of the three-leg lift shown in FIG. 3,

FIG. 5 is a side view of an extended three-leg lift, and

FIG. 6 is a top view of the three-leg lift shown in FIG. 5.

### DETAILED DESCRIPTION OF THE PREFERRED EMBODIMENTS

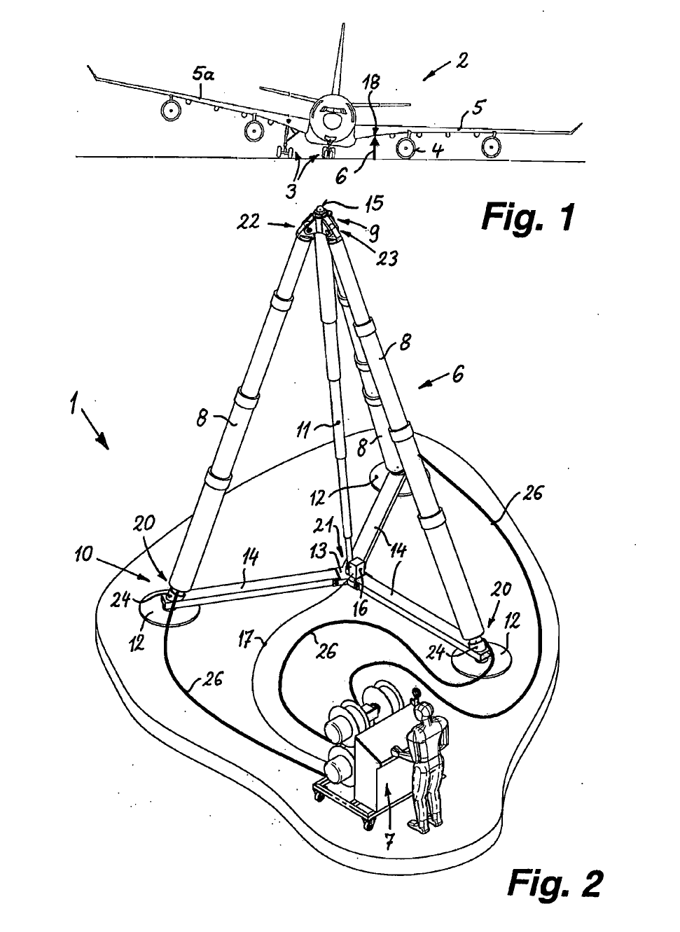

In the exemplary embodiment, a lifting system 1 shown in FIG. 2 is used for recovering airplanes 2 involved in accidents, as shown schematically in FIG. 1. In the illustrated embodiment, for the airplane 2, only two of the three landing gear legs 3 have extended, so that the airplane is lying on an engine nacelle 4 on the other side, where the landing gear is retracted. For recovering this airplane, it is necessary to lift the lowered side with a lift 6 underneath the lowered left wing 5 so that the still retracted, left landing gear leg can be extended. The lift 6 is represented symbolically by an arrow.

The lift 6 is part of the lifting system 1 shown in FIG. 2, which comprises, in the exemplary embodiment, a three-leg lift 6 and also a control unit 7. The three-leg lift 6 has, in the exemplary embodiment, three multi-telescoping, lifting cylinders 8 which are arranged in a pyramid shape and which attach, at their upper ends, to a docking head 9 and which are supported on the ground side on a base frame 10. In the exemplary embodiment, a telescoping middle brace 11 is also provided, which receives no axial forces and which has merely a guide function for the docking head 9.

The base frame 10 has three foot plates 12 for the lifting cylinders 8, a middle support 13 for the middle brace 11, and also braces 14, which connect the foot plates 12 and the middle support 13. The braces 14 can be rigid or can be adjustable in length. In this way the foot circle and thus the side stability of the lift 6 can be varied. In addition, adaptation to the provided local conditions is also possible in this way. Finally, in this way the height of the lift 6 can also be changed, which can be advantageous especially in the retracted position. By increasing the foot circle, namely the minimum height can be reduced somewhat, so that in special cases the lift still fits under the object to be lifted.

The docking head 9 has, on the top side, a projection 15, which has, for example, a spherical shape and which is placed at an airplane receiving point 18 for lifting the airplane 2. The recovery system 1 has a measurement system for detecting the position of the docking head 9 and also for measuring the load on the docking head, wherein the measurement system is connected to a control device of the control unit 7. In this way, the individual lifting cylinders 8 can feature mutually independent, load-controlled or movement-controlled activation. For measuring the load, force sensors can be provided on the docking head 9 or else there is also the possibility that axial force sensors for measuring the load on the docking head are provided on the lifting cylinders 8.

Detecting the position of the docking head 9 can be carried out by length measurement devices on the lifting cylinders 8. For the embodiment shown in the figures with a middle brace 11, however, it is preferred that a length measurement device and also two angle measurement devices are provided on the middle brace 11 for detecting the position of the docking head 9. In FIG. 2, this arrangement of the length measurement device and also the two angle measurement devices on the middle brace is indicated symbolically by a housing 16 holding the measurement devices and the measurement lines 17 leading from the housing 16 to the control unit 7.

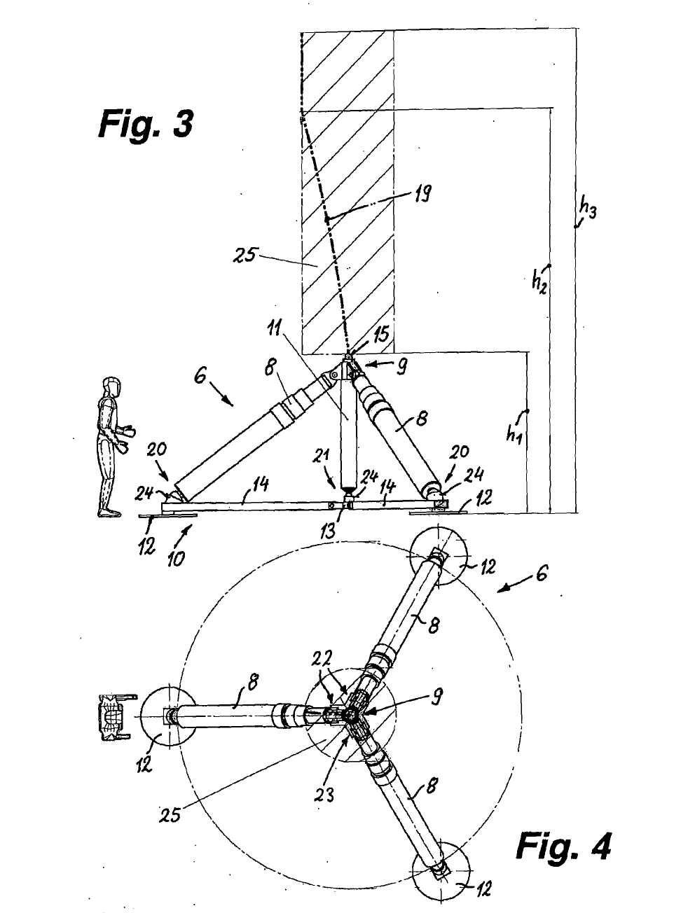

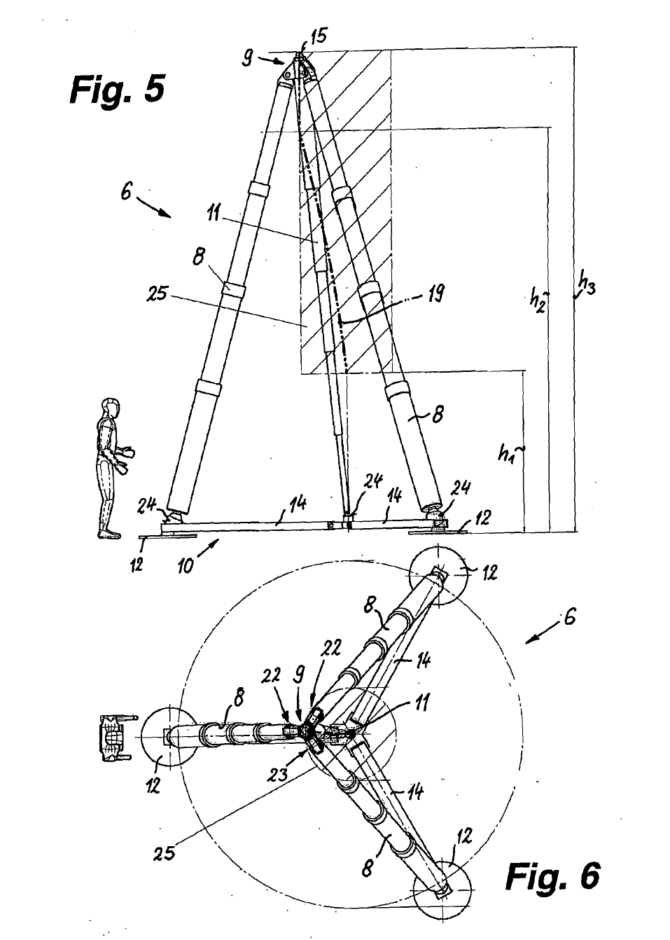

For the one-sided lifting of the airplane 2 shown in FIG. 1, the receiving point 18 provided on the airplane for placement of the lift 6 pivots about an axis running between the two ground contact points of the extended landing gear legs 3. In FIGS. 3 and 5, the profile of the curved lifting curve 19 is shown with dash-dot lines. When lifting the airplane it is necessary for the docking head 9 to follow the profile of the lifting curve 19. To realize this, the transverse forces acting on the docking head 9 during the lifting process are measured and the individual lifting cylinders 8 are controlled accordingly, in order to superimpose a side movement on the lifting movement.

Here, an electronic controller takes over the load-controlled travel of the lifting cylinders 8, so that the two-dimensional lifting curve 19 shown in FIGS. 3 and 5 is set. The airplane is here lifted essentially without side loads, wherein the three-leg lift or its docking head 9 follows the position profile path of the airplane receiving point 18.

In the illustrated embodiment, the three-leg lift 6 is operated in a force-controlled manner from a minimum height h₁ shown in FIGS. 3 and 4 up to a height h₂. In the embodiment, this lifting height h₂ is smaller than the maximum lifting height h₃. After lifting the airplane to the lifting height h₂, the wings are located in a horizontal position. If the landing gear is to be extended, additional lifting of the airplane as a whole is required. For this purpose, another three-leg lift is placed on the other wing 5a and the airplane 2 is then lifted in the vertical direction, for example, up to the position h₃. For vertical lifting, the control device is switched over to movement-controlled control. This is necessary because the prior contact points formed by the two intact landing gear legs 3 are no longer present or effective for further lifting. During the vertical lifting, transverse forces arising, for example, due to wind loading, should have no affect on the control of the lifting cylinder 8.

The working range 25 of the three-leg lift 6 is shown shaded in FIGS. 3 to 6. In FIGS. 3 and 5, it can be seen easily that in the example shown, the profile of the lifting curve lies within this working range 25. If the receiving point 18 on the airplane 2 should wander out of the range defined as the working range during lifting, which is the case, for example, when the lifting curve is more strongly curved, it would be necessary in such special cases to support the airplane in this intermediate position and to position the three-leg lift 6 in such a way that in this intermediate position a centered positioning of the three-leg lift 6 is given underneath the receiving point 18.

The lifting height h₁ of the lift 6 can equal, for example, 220 centimeters, the lifting height h₂ 520 centimeters, and the maximum lifting height 620 centimeters.

For a statically determined system, through which transverse forces can also be transmitted, different linkages to the lifting cylinders 8 can be provided on the foot side and head side. In the illustrated embodiment according to FIGS. 2 to 6, where, in addition to the three lifting cylinders 8, the middle brace 11 is also provided, the three foot points 20 of the lifting cylinders 8 and the foot point 21 of the middle brace 11 are mounted in ball-and-socket joints 24, while the connection between two of the upper cylinder ends and the docking head is realized by joint heads 22 and the connection between the third upper cylinder end and the docking head is realized by a pivot connection 23 with a flange and a transverse pin. The upper end of the middle brace 11 is connected rigidly to the docking head 9.

It should also be mentioned that for each lifting cylinder 8, a fall safety device could be provided, for example, with a manual or electrical safety master device.

The three-leg lift 6 can be disassembled into transport units with a defined maximum weight of, for example, 2000 kilograms. Therefore, simplified transport to the site of use is possible. For the transport to the site of use of the complete lift or of transport units of the disassembled lift, for example, recovery sleds can be used for typical embodiments.

The control unit 7 shown in FIG. 2 and set off from the three-leg lift 6 can comprise at least one hydraulic pump, control valve, hydraulic tank, and similar equipment. The measurement lines 17 and also power supply lines 26 can be wound onto drums 27, wherein these drums 27 are housed together with the control unit 7 on a carriage 28.

The lifting system 1 can also be used for simulating different positions of an airplane that has been jacked up on three lifts 6 according to the invention. In this way, not only a change in position about the transverse axis and the longitudinal axis of the airplane, but also about its height axis can be performed.

1. Lifting system (1) for lifting loads (2), comprising a lift (6), which can be positioned underneath a load, the lift (6) includes at least three lifting elements (8) and a docking head (9) for coupling with a load receiving point, a measurement system for detecting a position of the docking head (9) and also for measuring a load vector occurring on the docking head (9), and a control device is connected to the measurement system for mutually independent, load-controlled, or movement-controlled activation of drives for the individual lifting elements.

2. Lifting system according to claim 1, wherein the measurement system includes force sensors for measuring the load on the docking head (9).

3. Lifting system according to claim 1, wherein the measurement system includes axial force sensors or pressure sensors on the lifting elements (8) for measuring the load on the docking head (9).

4. Lifting system according to claim 1, wherein the measurement system includes length measurement devices on the lifting elements (8) for detecting the position of the docking head (9).

5. Lifting system according to claim 1, wherein in addition to the lifting elements (8), a telescoping middle brace (11) is provided on the lift (6).

6. Lifting system according to claim 5, wherein there are three of the lifting elements (8) and the middle brace (11), the measurement system includes a length measurement device and also two angle measurement devices provided on the middle brace (11) for measuring the position of the docking head (9).

7. Lifting system according to claim 1, wherein there are three of the lifting elements (8), and foot points (20) of the lifting elements are mounted in ball-and-socket joints (24) and connections between upper lifting element ends and the docking head (9) are provided by pins.

8. Lifting system according to claim 1, wherein there are three of the lifting elements (8) and one middle brace (11), and four foot points (20) of the lifting elements and the middle brace are mounted in ball-and-socket joints (24) and a connection between two upper lifting element ends and the docking head (9) is provided by ball-and-socket joints (22), a connection between the third upper lifting element end and the docking head (9) is provided by a pin (23), and a connection between the middle brace (11) and the docking head (9) is rigid.

9. Lifting system according to claim 1, wherein there are three of the lifting elements (8) and one middle brace (11), and foot points (20) of the lifting elements (8) are mounted in ball-and-socket joints (24) and a foot point (21) of the middle brace (11) is gimbaled and a connection between upper lifting element ends and the docking head (9) is provided by ball-and-socket joints (22) and a connection between the middle brace (11) and the docking head (9) is rigid.

10. Lifting system according to claim 1, wherein a fall safety device is provided for each of the lifting elements (8) of the lift (6).

11. Lifting system according to claim 1, wherein the lifting elements (8) of the lift (6) are constructed as telescoping cylinders.

12. Lifting system according to claim 1, the lift (6) is disassembleable into transport units with a defined maximum weight.

13. Lifting system according to claim 1, wherein the lift (6) has a telescoping middle brace, a base frame (10) with foot plates (12) for the lifting elements (8), a middle support (13) for the middle brace (11), and braces (14) connecting the foot plates and the middle support.

14. Lifting system according to claim 1, wherein a control unit (7), which comprises a hydraulic pump, control valve, and hydraulic tank, is allocated to the lift (6) as part of a recovery system, the control unit (7) is housed, on a carriage (28), and a connection to the lift (6) is provided by power supply and measurement system lines (26, 17).

15. Lifting system according to claim 14, wherein the control unit (7) has a hydraulic pump driven electrically by a generator.

16. Lifting system according to claim 14, wherein the control unit (7) has an air-hydraulic pump driven by a compressor.

17. Lifting system according to claim 1, wherein a lifting height of the lift (6) in an extended position equals approximately 4 m to approximately 7 m.

18. Lifting system according to claim 1, wherein a structural height and a lifting height of the lift (6) in a retracted position equals approximately 1 m to approximately 2 m.

19. Lifting system according to claim 1, wherein the control device of the control unit (7) has particular, an electronic controller with a microprocessor and proportional valves with both load-controlled and also movement-controlled operation.

20. Lifting system according to claim 1, wherein the lifting elements (8) are hydraulic lifting cylinders or electromechanical lifting cylinders.

21. Lifting system according to claim 1, wherein the lifting elements (8) can be moved individually.

22. Lifting system according to claim 1, wherein the load to be lifted is an airplane (2) to be recovered following an accident, and the lift (6) can be placed on an airplane receiving point (18) underneath a wing (5) of the airplane.
